(19) United States
(12) Patent Application Publication
(10) Pub. No.: US 2026/0164506 A1
(43) Pub. Date: Jun. 11, 2026

(54) METHOD FOR PLACING AN EMERGENCY CALL

(71) Applicant: AUDI AG, Ingolstadt (DE)

(72) Inventor: Thorsten HEHN, Ingolstadt (DE)

(73) Assignee: AUDI AG, Ingolstadt (DE)

(21) Appl. No.: 19/103,955

(22) PCT Filed: Jul. 31, 2023
(86) PCT No.: PCT/EP2023/071193

§ 371 Date: Feb. 14, 2025

(30) Foreign Application Priority Data
Aug. 17, 2022 (DE) 10 2022 120 808.7

(51) Int. Cl. H04W 76/50; H04W 4/021; H04W 4/40; H04W 64/00

(52) U.S. Cl. CPC H04W 76/50; H04W 4/021; H04W 4/40; H04W 64/00

(57) ABSTRACT

A method of placing an emergency call from a vehicle, based on a determined area of the vehicle. First and second paths which differ from one another are set up proceeding from a present position of the vehicle using geodata relating to boundaries assigned to immediately adjacent areas which lie between said areas. The method checks a boundary intersected first by the first path and which boundary is intersected first by the second path. Based on both routes intersecting the same boundary, a new first and a new second paths are set up. Based on the boundaries that are intersected first by the two paths proceeding from the present position differing from one another, the area to which the boundaries are assigned is determined as being the area in which the vehicle is presently situated, and the emergency call is placed based on the determined area.

### CROSS REFERENCE TO RELATED APPLICATIONS

This application is a U.S. national stage of International Application No. PCT/EP2023/071193, filed on Jul. 31, 2023, which claims the priority benefit of German Application No. 10 2022 120 808.7 filed on Aug. 17, 2022. Both the International Application and the German Application are incorporated by reference herein in their entirety.

### BACKGROUND

### 1. Field

The described examples of an invention may relate to a method for placing an emergency call, and to a system for placing an emergency call.

### 2. Description of the Related Art

The publication DE 10 2016 204 823 A1 describes a GPS-based area recognition system in a vehicle.

A method for sensing a proper position in relation to the course of a boundary is described in the publication DE 10 2020 211 392 A1.

The publication US 2016/217151 A1 presents a technique for representing geographical data by means of a polygon.

The known prior art is the “Regulation (EU) 2015/758 of the European Parliament and of the Council”, Official Journal of the European Union (DE), L 123, pp. 77-89, 2015, and the article by J. Snoeyink: “Point Location” preliminary version (Aug. 10, 2017) from “The Handbook of Discrete and Computational Geometry”, J. E. Goodmann, J. O'Rourke, and C. D. Töth (editors), 3rd edition, CRC Press, Boca Raton, FL, 2017.

Also known are course documents relating to CS166, Lecture 11 on Planar Point Location, 2021, by K. Schwarz et al., and the slides relating CS164 and CS266, Computational Geometry, Week 6: Point location, Reading: Section 6.1, 2020, by M. Goodrich.

### SUMMARY

Against this background, an examples of the present invention is that of placing an emergency call dependent on position.

The examples may be a method and a system having the features of the independent patent claims. Embodiments of the method and of the system are presented in the dependent claims and the description.

In an example, a method is envisaged for placing an emergency call from a vehicle, for example a motor vehicle. In this method, the geographical area in which the vehicle is currently located, or present, is first established and/or determined. Starting from a current position of the vehicle in the area to be determined, a first path and a second path are laid out, which are usually straight lines that differ from one another in respect of their direction, starting from the current position, and which are usually selected at random. Using provided and/or established geodata of boundaries that are assigned to respectively two directly adjacent areas and that lie between these adjacent areas, it is checked which boundary is the first to be intersected by the first path starting from the current position of the vehicle, and which boundary is the first to be intersected by the second path starting from the current position of the vehicle. If both paths each intersect the same boundary running between the same areas, a new first path and a new second path are laid out starting from the current position of the vehicle. In addition, for the usually alternative case in which the boundaries that are respectively the first to be intersected by the two paths starting from the current position of the vehicle differ from one another, the area to which both boundaries, for example area boundaries, are assigned is determined as being the area in which the vehicle is currently located, wherein the emergency call is placed automatically by the vehicle, for example by a communication module of this vehicle, in dependence on the geographical area that is determined.

As a development, if two first-time laid-out paths each intersect the same boundary, i.e. in each case the boundary between the same directly adjacent areas, these first-time laid-out paths are discarded. Furthermore, starting from the respectively current position of the vehicle, a new first path and a new second path are laid out until both paths each intersect the boundary between two different directly adjacent areas. If the vehicle is stationary and is at least temporarily in one and the same position, the paths to be laid out initially and the new paths to be laid out if necessary are each laid out starting from the same position. If the vehicle is travelling and moving, its position will change. In this case, the paths to be laid out initially are laid out starting from a first position of the vehicle, and the new paths to be laid out if necessary are laid out starting from a second position of the vehicle.

Generally, a respective boundary is located between respectively two directly adjoining areas, which as a development form a pair of directly adjacent areas separated by this common boundary assigned to the areas. In this case, the first rectilinear path intersects a first boundary between a first pair of areas, and the second rectilinear path intersects a second boundary between a second pair of areas. If both pairs have the same two areas, according to a first case new paths are to be laid out starting from the respectively current position. If the first boundary lies between a first pair of areas and the second boundary lies between a second pair of areas, in a second case the area in which the vehicle is located, or present, is determined on the basis thereof. The first pair of areas comprises a first area and a second area, and the second pair also comprises the first area and a further, third area, the two pairs comprising a total of three different areas, the area in which the vehicle is located belonging to both pairs of areas. Areas under consideration here include the area to be determined, or area that is determined, in which the vehicle is located, and two different areas directly adjoining it.

Starting from the position, the first and the second path are laid out in different directions, an angle between the two paths being greater than 0° and less than 360°, a possible angle between the paths being, for example, 90° or 180°, with in the latter case the two paths being aligned and/or orientated in opposite directions.

Envisaged or considered as an area is a country, a state, a federal state, a territory usually recognized under international law and/or a body of water, for example a sea, an ocean, a lake and/or a river. It is thus possible for one area of a pair to be a country, or mainland, and a second area to be a body of water, that directly adjoin each other, in which case a boundary between a country and a body of water may also be referred to as a water boundary, for example a sea boundary.

The system according to the invention is designed for placing an emergency call from a vehicle, wherein the system comprises a computing unit and a communication module, which are generally also components of the vehicle. The computing unit is designed to first establish and/or determine the area in which the vehicle is currently located, wherein the computing unit, for the purpose of establishing the area to be determined, is designed, starting from a current position of the vehicle in the area to be determined, to lay out a first path and a second path, wherein the paths differ from one another, and, using provided and/or established geodata of boundaries that are assigned to respectively two directly adjacent areas and that lie between these adjacent areas, to check which boundary is the first to be intersected by the first path starting from the current position, and which boundary is the first to be intersected by the second path starting from the current position. The computing unit is designed, if both paths intersect the same boundary, to lay out a new first path and a new second path starting from the respectively current position. The computing unit is designed, if the boundaries that are respectively the first to be intersected by the two paths, starting from the position, differ from each other, to determine the area to which both boundaries are assigned as being the area in which the vehicle is currently located. The communication module is designed, in dependence on the area that is determined, to automatically place the emergency call from the vehicle to an emergency call centre in this determined area, and to send it to this emergency call centre.

It is possible for an embodiment of the method presented to be performed by means of an embodiment of the system presented. The method provides an efficient algorithm for determining the country in which the vehicle is currently located, in consideration of which the emergency call, or eCall, is triggered, it being possible to send the emergency call to a telephone number specific to the respective country and/or to take into account for the emergency call a language of the respective country.

As a development, the computing unit is designed to project the boundaries and/or paths onto a coordinate system into which the areas are entered.

As a development, the system has a geodata module that is designed to provide the geodata directly to the computing unit, or indirectly via the communication module. The geodata module is arranged in the vehicle, for example as part of a navigation system, or realized as part of a server that is external to the vehicle and/or a fixed-location server.

As a development, two randomly selected but differently orientated paths are laid out from the current position, with an angle of greater than 0° and less than 360° between them.

Tracked for both paths is when they first meet a boundary, for example a national boundary. A first boundary, which is intersected by the first path, is located between an area, e.g. country A, and an area, e.g. country B. Similarly, a second boundary, which is intersected by the second path, is located between an area, e.g. country C, and an area, e.g. country D. If these two boundaries are known, it is checked whether two of the four areas mentioned, along a respective path in the direction of the current position, point to the same area, this area being a country in which the vehicle is located. Alternatively or additionally, this is also possible if three of the four areas are different, the vehicle being located in the area that is duplicated among these four areas. Otherwise, if, for example, only two of the four areas or all four areas are different, the algorithm is repeated with two new paths, which are newly selected and likewise have random directions.

In the case of the algorithm provided, it is envisaged to find, starting from the given position, two nearest, different national boundaries that have a country in common. In a first example, along the first path, country A is France and country B is Germany. Along the second path, country C is Germany and country D is the Czech Republic. It is therefore decided that the country in which the vehicle located is Germany. In a second example, along the first path, country A is France and country B is Germany and, along the second path, country C is France and country D is Germany. In this case, the algorithm must be repeated with two new, randomly aligned paths. In a third example, country A is France and country B is Germany. In addition, along the second path, country C is France and country D is Switzerland, and it is decided that the country in which the vehicle is located is France. As a development, the method may also be performed for a country that has only one neighboring country and otherwise adjoins a sea. In this case, within the method the neighboring country is considered as a first area and the sea as a second area. This is possible, for example, for Portugal, which adjoins both Spain and the Atlantic Ocean.

Serving as a basis are the geodata of the national boundaries and their projection in and/or onto the coordinate system used. This coordinate system is predefined in the vehicle, for example in the computing unit, by a GNSS receiver, for example in the communication module. In contrast to conventional map data for navigation, the memory size of which is usually in the range of from 10 to 20 GB, the area boundaries, for example national boundaries, of the world can be mapped with a file size of less than 100 KB. If the national boundaries are known, it is then necessary to determine algorithmically which country the current position corresponds to. In particular, the use of tiles may be dispensed with here, as these are inaccurate and result in a loss of storage efficiency. The method proposed here can be implemented efficiently in the vehicle. This means that it is efficient in respect of memory and requires and/or occupies only a small amount of permanent memory and working memory. It is also efficient in terms of computing power. The method is suitable, inter alia, for a boundary area, with the position being close to a boundary between two adjacent countries.

With the emergency call, or a corresponding function for this, a digital data and voice connection is established to the emergency call centre and/or a rescue control centre in the event of an emergency involving the vehicle. The emergency call and/or the function may be triggered in two ways, namely manually by a user, for example the driver, of the vehicle, for example in the event of a medical emergency, and automatically by the vehicle, for example its computing unit, the control centre being notified of an accident. In both cases, important items of information such as the position of the vehicle, the number of occupants and the drive type of the vehicle, which may be realized as a combustion, hybrid or electric vehicle, are transmitted to the rescue control centre. To automatically trigger the emergency call function, for example an airbag control device detects the accident, a message about this event, and any further messages, are transmitted to a connectivity unit that runs a function for placing the emergency call. Two versions of the emergency call function are provided. In the case of a private emergency call, a call centre operated specifically for this purpose by a vehicle manufacturer is called. Alternatively, the rescue control centre is called directly. Irrespective of which version is provided in a particular case, the current country in which the vehicle is located can be taken into consideration before an emergency call is placed, and the emergency call placed automatically in dependence on this.

The method makes it possible to determine the country in which a vehicle is currently located. A GNSS position for establishing the current position of the vehicle, and geographical map data relating to the areas and the boundaries between them, may be provided to the computing unit via the geomodule, and the GNSS position can be compared with the map data. In addition, the communication module may be used to query an identifier of a mobile phone provider of the country determined by the method. This identifier comprises a mobile country code (MCC) and a mobile network code (MNC), this identifier being used to place the emergency call. It is possible for a mobile telephony modem of the communication module to report that the current mobile telephony provider has, for example, the identifier 262-03 for “o2-de”. In this case, the country code MCC 262 indicates that the vehicle is located in Germany or in a boundary area of one of Germany's neighboring countries or states. It is possible for the method also to be performed for a vehicle that does not have a navigation system, and therefore has no map data. Usually, according to measures known to date, querying of the mobile country code (MCC) and of the mobile network code (MNC) via the mobile telephony modem may only be effected if the mobile telephony modem is actively monitoring a mobile telephony network, such that the mobile telephony modem has to be activated accordingly. However, a mobile telephony modem is not usually required in order to realize the method. It should also be taken into consideration that legislation requires that when an emergency call (eCall) is placed, the mobile telephony modem withdraws to relieve the mobile telephony network if no further services are active in addition to the emergency call, and the mobile telephony modem is in a dormant mode.

It is understood that the above-mentioned features and those to be explained below can be used not only in the respectively indicated combination, but also in other combinations or on their own, without departing from the scope of the present invention.

### BRIEF DESCRIPTION OF THE DRAWINGS

The invention is represented schematically in the drawing on the basis of embodiments, and is described schematically and in detail with reference to the drawing. These and other aspects and advantages will become more apparent and more readily appreciated from the following description of the exemplary embodiments, taken in conjunction with the accompanying drawings of which:

FIGS. 1a, 1b show schematic representations of an embodiment of the method according to an example.

FIG. 2 shows a schematic representation of a vehicle, and of an example of the system by which the method is performed.

### DETAILED DESCRIPTION

Reference will now be made in detail to the preferred embodiments, examples of which are illustrated in the accompanying drawings, wherein like reference numerals refer to like elements throughout.

The figures are described in a coherent and comprehensive manner. Components that are the same are denoted by the same reference designations.

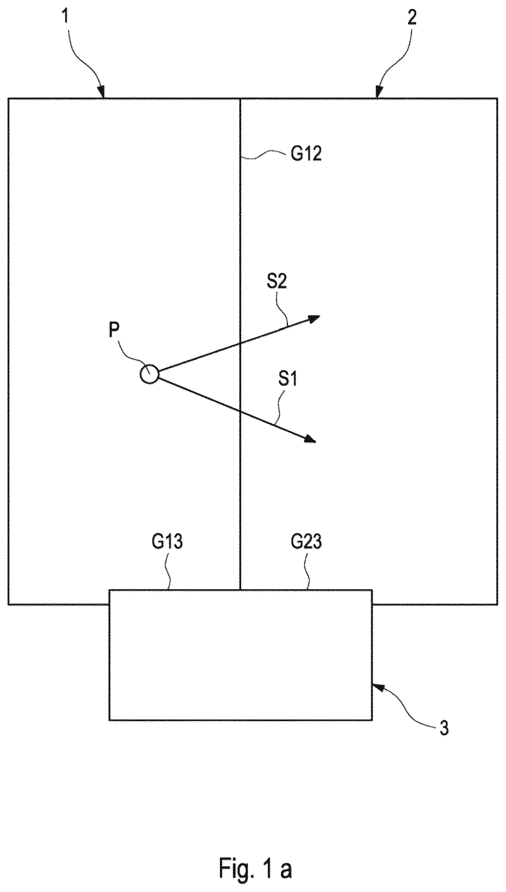

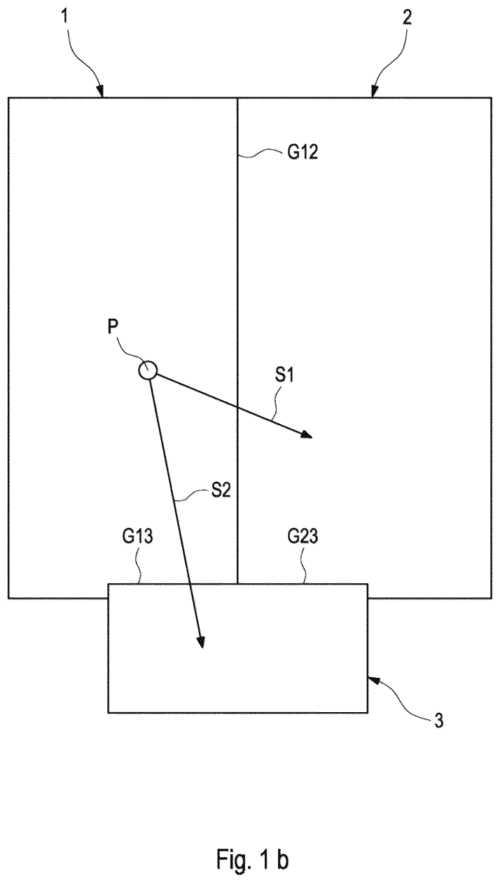

FIGS. 1a and 1b (1a and 1b) show as geographical areas a first country 1, a second country 2 and a third country 3, with a first boundary G12 between the first and second country 1, 2, a second boundary G13 between the first and third country 1, 3, and a third boundary G23 between the second and third country 2, 3.

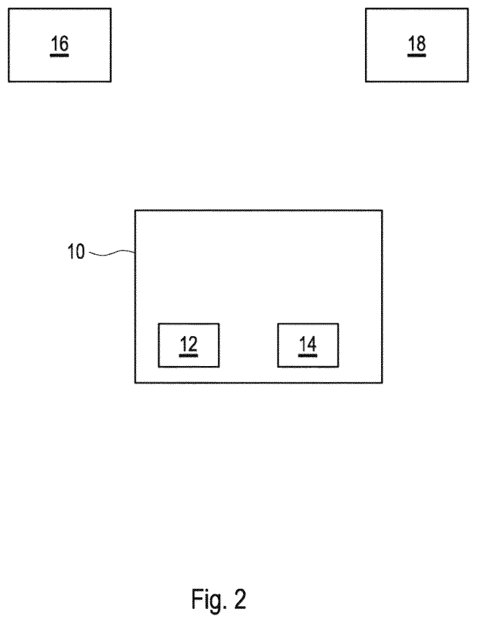

The embodiment of the method according to the invention is performed for the vehicle 10 of FIG. 2, which has a computing unit 12 and a communication module 14, which are also realized as components of the embodiment of the system according to the invention, which has as further components a geodata module 16, which here is of fixed-location type, for example server-supported, and an emergency call centre 18, or rescue control centre.

It is envisaged that the vehicle 10 is located at a position P shown in each of FIGS. 1a and 1b, although which country 1, 2, 3, as a possible area, the position P is located in is initially unknown. In the embodiment of the method presented here, this area, and thus this country 1, 2, 3, is determined. Starting from the current position P of the vehicle 10 in the area to be determined, a first path S1 and a second path S2 are laid out, which here are realized as straight lines and differ from each other in respect of their direction. Furthermore, using geodata, provided by the geodata module 16 to the communication module 14 and thus to the computing unit 12, of respectively two directly adjacent countries 1, 2, 3 and their assigned boundaries G12, G13, G23, which lie between these countries 1, 2, 3, it is checked which boundary G12, G13, G23 is the first to be intersected by the first path S1 starting from the current position P, and which boundary G12, G13, G23 is the first to be intersected by the second path S2 starting from the current position P of the vehicle 10.

A first case and/or attempt to determine the country 1, 2, 3 is illustrated here by FIG. 1a, which shows that both paths S1, S2 extend from the first country 1 to the second country 2, and each intersect the same, or the same first, boundary G12 between these two countries 1,2 Since a result of this first attempt is not informative as a development of the method, a new first path S1 and a new second path S2 are laid out in a second case and/or attempt, starting from the current position P, as shown in FIG. 1b.

The first new path S1 extends from the first country 1 to the second country 2, intersecting the first boundary G12. In contrast, the second new path S2 extends from the first country 1 to the third country 3 and intersects the second boundary G13, the two boundaries G12 and G13 being different from each other. In this case, the first country 1 is determined as the country in which the vehicle 10 is currently located and to which the two different boundaries G12, G13 are assigned. In dependence on this determined country 1, the emergency call is placed automatically by the communication module 14 of the vehicle 10 and sent to the emergency call centre 18, which is located in this determined first country 1.

### REFERENCE DESIGNATIONS:

1, 2, 3 country
G12, G13 boundary
G23
P position
S1, S2 path
10 vehicle
12 computing unit
14 communication module
16 geodata module
18 emergency call centre.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A method of placing an emergency call from a vehicle, comprising:
determining an area in which the vehicle is currently located starting from a current position of the vehicle and laying out a first path and a second path, which are straight lines that differ from one another in respect of direction, and which are selected at random; and
using provided geodata of boundaries that are assigned respectively to two directly adjacent areas and that lie between adjacent areas, checking which boundary is a first to be intersected by the first path starting from the current position, and which boundary is the first to be intersected by the second path starting from the current position of the vehicle,
wherein, based on both the first path and the second path intersecting a same boundary, a new first path and a new second path are laid out, starting from the current position of the vehicle, which are straight lines that differ from one another in respect of direction, and which are selected at random,
wherein, based on the boundaries that are respectively first to be intersected by the first path and the second path, starting from the current position and differ from one another, an area to which the boundaries are assigned is determined as being the area in which the vehicle is currently located,
wherein the emergency call is placed based on the area that is determined.

10. The method as claimed in claim 9, wherein the area is one of a country, a state, a federal state, a territory recognized under international law and/or a body of water.

11. The method as claimed in claim 9, wherein based on two first-time laid-out paths each intersecting the same boundary between same directly adjacent areas, the two first-time laid-out paths are discarded, and
wherein, starting from the current position, a new first path and a new second path are laid out until the boundaries respectively intersected by both first path and the second path differ.

12. The method as claimed in claim 9, wherein starting from the current position, the first path and the second path are laid out in different directions.

13. The method as claimed in claim 9, wherein a country is considered as at least one first area.

14. The method as claimed in claim 13, wherein a body of water is considered as at least one second area.

15. A system of placing an emergency call from a vehicle, comprising:
a communication module; and
a computing unit to:
determine an area in which the vehicle is located, starting from a current position of the vehicle in the area, to lay out a first path and a second path, which are straight lines that differ from one another in respect of direction and selected at random, and
using provided geodata of boundaries that are assigned to respectively two directly adjacent areas and that lie between these areas, to check which boundary is a first to be intersected by the first path starting from the current position of the vehicle, and which boundary is the first to be intersected by the second path (S2) starting from the current position (P) of the vehicle,
wherein, based on both the first path and the second path intersecting a same boundary, the computing unit is designed to lay out a new first path and a new second path starting from the current position, which are straight lines that differ from one another in respect of direction and which are selected at random,
wherein, based on the boundaries that are respectively first to be intersected by the first path and the second path, starting from the current position of the vehicle, and differ from one another, an area to which the boundaries are assigned is determined as being the area in which the vehicle is currently located,
wherein the communication module is designed to place the emergency call in dependence on the area that is determined.

16. The system as claimed in claim 15, the area is one of a country, a state, a federal state, a territory recognized under international law and/or a body of water.

17. The system as claimed in claim 15, wherein the computing unit is designed to project the boundaries onto a coordinate system.

18. The system as claimed in claim 15, comprising a geodata module that is designed to provide the geodata to the computing unit.
